(19) United States
(12) Patent Application Publication
(10) Pub. No.: US 2005/0118064 A1
(43) Pub. Date: Jun. 2, 2005

(54) Sensor system and method

(76) Inventor: Anne Berg, Kattem (NO)

Correspondence Address: William B Patterson;Moser Patterson & Sheridan, 3040 Post Oak Boulevard, Suite 1500, Houston, TX, 77056, US

(21) Appl. No.: 10/501,742

(22) PCT Filed: Dec. 23, 2002
(86) PCT No.: PCT/GB02/05907

(30) Foreign Application Priority Data
Dec. 27, 2001 (NO) 2001-6358

(51) Int. Cl. G01N 21/64

(52) U.S. Cl. 422/91; 422/88; 436/164

(57) ABSTRACT

A sensor system for the detection or measurement relating to a chemical environment, comprising an optical fibre, an optical source for launching light into the optical fibre, the sensor system being adapted to let a gas, e.g. hydrogen derived from said chemical environment, diffuse into the optical fibre. The gas thereby alters the optical properties of the optical fibre. The system comprises optical signal detection and signal analysing means adapted for determining changes in the optical properties of the optical fibre due to the in-diffusion of the said gas. The signal analysis means is adapted to derive from the determined changes at least one characteristic value representing the chemical environment.

This invention relates to a sensor system for the detection of or measurement relating to a chemical environment. The invention finds particular application in the detection of the presence of hydrogen gas.

It is well known that hydrogen gas can diffuse into optical fibres and generate additional transmission loss at certain wavelengths [1]. Due to its small size, the hydrogen gas molecule, H₂, which in many situations is present around an optical fibre, can diffuse into the central light-guiding core region of the optical fibre, causing increases in the optical loss of the fibre. This has hitherto been regarded as an undesired effect, as increased loss implies reduced information transmission capacity in fibre-optic based long-haul optical communication systems. Such loss could for example be due to hydrogen originating either from polymeric materials or from galvanic corrosion cells present in submerged cables [1]. Such problems have been dealt with by altering the fibre dopant compositions, redesign of the fibre cables to avoid the possibility of hydrogen generation and employing steel tube protection around the, optical fibres to block the diffusion of any hydrogen that might be present in a cable [1]. In summary, a clear trend existed to prevent or reduce diffusion of hydrogen into the optical fibre.

The present inventor has appreciated that the diffusion of hydrogen into optical fibres is not only an undesired effect, but can be used advantageously to detect or measure hydrogen directly and/or other gases and liquids indirectly by the use of the above described effect.

Hence, an objective of preferred embodiments of the present invention is to provide a system for monitoring the chemical environment in surroundings where optical fibres can be placed and used as a sensor.

In particular it is an objective of preferred embodiments of the invention to provide an apparatus which can be, used as a sensor for monitoring flexible risers in offshore environments.

Aspects of the invention are set out in the independent claims.

Preferred features are set out in the dependent claims.

Apparatus aspects corresponding to method aspects disclosed herein are also provided, and vice versa.

It is envisaged that the monitoring of flexible risers in offshore environments can be achieved by using a sensor system according to the invention for monitoring the corrosion and/or the environmental conditions of the risers.

Some preferred embodiments of the invention will now be described by way of example only and with reference to the accompanying drawings, in which:

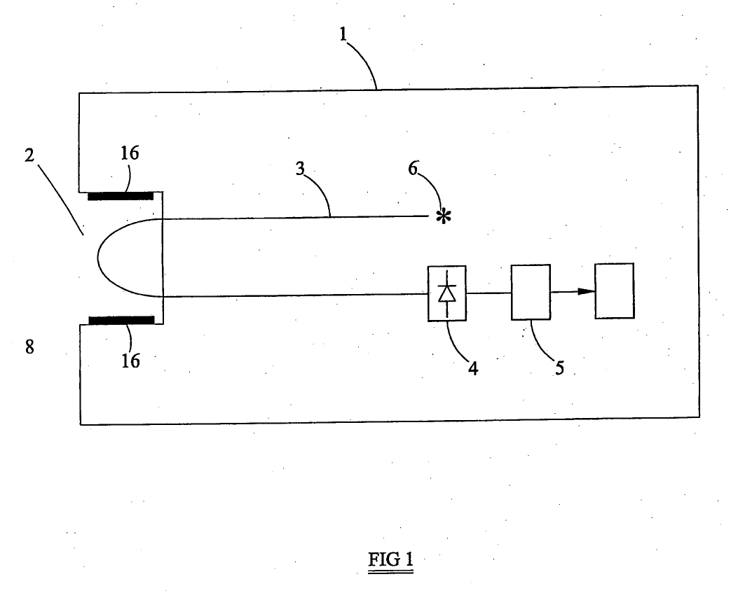

FIG. 1 illustrates schematically a sensor system where reaction elements or catalysts are exposed to a chemical environment.

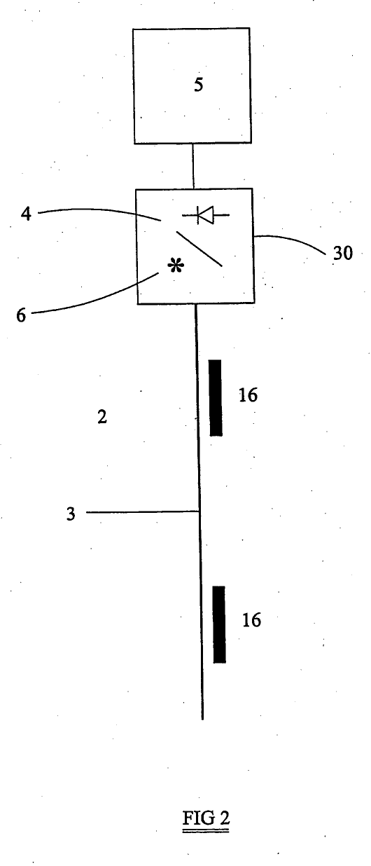

FIG. 2 illustrates schematically a distributed sensor system with a read-out unit of the OTDR or Bragg type.

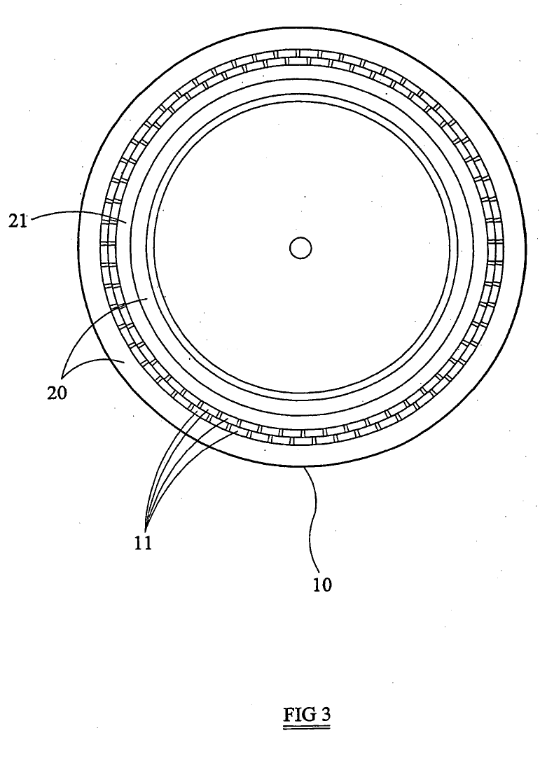

FIG. 3 illustrates a cross-section of a riser with armour wires,

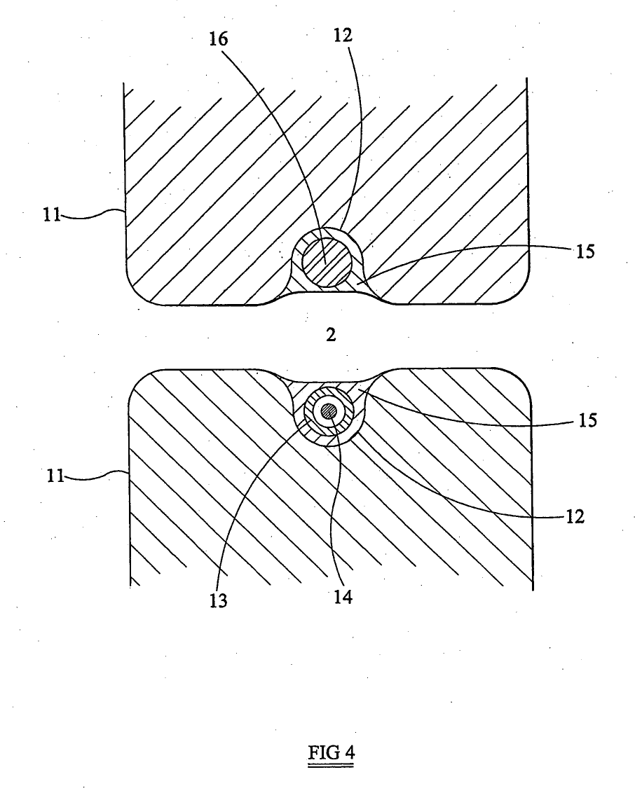

FIG. 4 illustrates a cross-section of two neighbouring armour wires with embedded optical fibre and reactant/catalyst and,

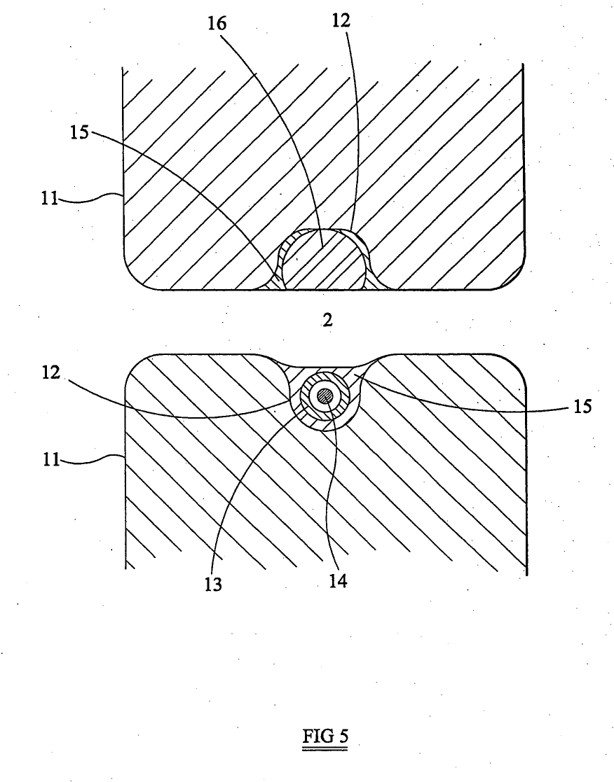

FIG. 5 illustrates a cross-section of two neighbouring armour wires with a reactant/catalyst directly exposed to the chemical environment.

FIG. 1 illustrates schematically a sensor system 1 for measurement in a surrounding chemical environment 2. The optical part of the system comprises a light source 6 launching light into an optical fibre 3. The optical fibre is arranged to allow a gas, e.g. hydrogen, derived from the chemical environment 2 to diffuse into at least a part of the optical fibre 3. The gas diffusing into the optical fibre changes the transmission characteristics (e.g. transmission loss) of the optical fibre 3.

The gas can be derived from the chemical environment 2 by generation in chemical processes (e.g. corrosion) normally initiated by the chemical environment itself. The gas can also be derived from the chemical environment by the placement of additional elements 16, e.g. reactants or catalysts, that generate hydrogen gas directly when the materials to be detected (e.g. water) are present in the chemical environment 2. The additional elements may not generate the gas directly, but could also generate a gas indirectly by taking part in a chemical process resulting in the generation of the gas, e.g. hydrogen. Upon diffusing into the core of the optical fibre the gas, e.g. hydrogen, causes an additional optical loss in the fibre. This additional loss can be measured and the fibre thereby represents a sensing element for the detection of constituents of the chemical environment which initiates the formation of the gas causing this additional loss.

The sensor system 1 may comprise inlet means 8 to allow a part or sample of the chemical environment to enter the sensor system. In this case one or more reaction elements or catalysts 16 are arranged on the inside of the inlet means as with regard to the chemical environment in such a way that the reaction elements or catalysts only react with the part or sample of the chemical environment that passes through the inlet means 8. The inlet means 8 may have a control function in order to allow parts or samples of the chemical environment 2 to enter the sensor system at given times, during given periods, at given temperatures of the chemical environment or other predetermined conditions. The inlet means 8 may also comprise selective membranes for allowing only specific constituents of the chemical environment to enter the sensor system. Having the reactive elements or catalysts 16 inside inlet means may have the advantage of making it easier to control or monitor the temperature and other conditions of the elements.

FIG. 2 illustrates an example of the system in a distributed sensor configuration. Two reaction elements or catalysts 16, which may be of similar or dissimilar types, are placed at different positions along the length of the optical fibre 3. The optical fibre extends some distance into the chemical environment 2 to be monitored. Alternatively, several reaction elements or catalysts 16 are placed at practically the same position. A read-out unit 30 may comprise signal detection 4 and signal analysing means 5 adapted for OTDR-measurements (optical time domain reflectometry) in order to resolve measurement positions along the length of the optical fibre 3.

In an alternative the optical fibre may comprise Bragg gratings placed along the length of the optical fibre. In this case the read-out unit 30 comprises a Bragg-wavelength read-out section for the separation of the Bragg wavelength of each Bragg grating along the optical fibre. Bragg gratings are typically placed next to reaction elements or catalysts 16.

An example of an application of the sensor principle is corrosion monitoring of flexible risers. Risers 10, as illustrated in FIG. 3, are made of various layers of metal and polymer to achieve the required performance. The tensile armouring 11, which is included to make the riser withstand tension, is located in an annulus between the extruded polymer layers 20. In addition, a pressure armouring layer 21 is normally included in the riser. The armour wires 11 are dimensioned to withstand the generated forces and the fatigue stress due to riser bending during the riser lifetime. However, corrosion of the armouring wires 11 will have a serious impact on the safety and lifetime of the riser 10. It is therefore important to detect any start of corrosion (hydrogen generation). Corrosion will start due to the ingress of water. Gases like carbon dioxide and hydrogen sulfide will strongly influence the corrosion process. It is therefore very important to detect the presence of these gases.

A technique to integrate small metal tubes with fibres and/or fibre Bragg gratings along the tensile wires has been developed. As illustrated in FIG. 4, the tubes 13 are bonded or encapsulated into grooves 12 in the sidewalls of the wires 11. Suitable encapsulants may be epoxies, polyurethanes, silicones or any other commonly used encapsulant, adhesive or sealing material. The wires 11 are terminated in the riser end fitting, and the sensor tubes can be connected to an external cable with the read out unit in a control room at the other end of the cable (to measure transmission loss).

The corrosion sensing system can detect hydrogen generated from the corrosion process itself, or reactants can be utilised. Reactants 16 can be embedded in the encapsulant 15 in the same manner as for bonding the fibre tube 13, applied onto the armouring wires 11 themselves or as separate elements in the annulus. Separate elements can for instance be mounted in similar grooves opposite to the grooves with the fibre sensors, as illustrated in FIG. 4. Reactants sensitive to water, carbon dioxide, hydrogen sulfide and/or other materials to be detected can be applied. As illustrated in FIG. 5, the reactants 16 can be embedded in epoxy 15 in a groove 12 of the armour wire 11 in such a way that a polishing process exposes a surface of the reactant or catalyst to the chemical environment 2.

The reactant 16 can also represent a galvanic protection of the wire 11 when the reactant material 16 represents a sacrificial anode with respect to the steel wire.

The additional loss caused by the gas diffusing into the optical fibre can be measured by monitoring the transmission loss. Optical signal detection means 4 and signal analysing and processing means 5 are adapted for determining changes in the optical properties of the optical fibre due to the additional loss caused by the in-diffusion of the said gas. The signal analysis and processing means 5 is adapted to derive from the determined changes at least one characteristic value representing the chemical environment 2. By using an optical time domain reflectometer (OTDR) technique the location of the additional loss along the optical fibre can also be determined.

In fibre Bragg gratings (FBG), indiffusion of hydrogen causes a change in the effective refractive index and will thereby generate a small shift in the reflected Bragg wavelength. Such a shift will represent a change in the environmental conditions. The shift can be monitored and a fibre Bragg grating can be used as a sensing element for hydrogen detection.

The additional loss in an optical fibre or change of Bragg wavelength in a fibre Bragg grating depends on the hydrogen concentration in the core of the fibre where the light is guided, and the core materials, e.g. glas dopants. The diffusion time for the hydrogen gas to penetrate into the fibre core depends on the fibre dimensions, coatings and temperature.

Factors other than the presence of hydrogen gas, for example micro- and macro bends, can also generate transmission loss in an optical fibre. The sensitivity and measuring accuracy can be improved by using a reference monitoring technique. The hydrogen can be detected more specifically by monitoring the transmission loss at the absorption peak (1244 nm). By measuring the loss at another wavelength besides the absorption peak (e.g. 1300 nm), this loss can be used as reference. The differential additional loss will then only be due to hydrogen and the monitoring accuracy can be improved considerably.

The reflected wavelength of a Bragg grating also depends on the temperature and strain in the fibre. Such effects can be compensated by putting two gratings close by where both are exposed to the same strain and temperature, but one is protected from hydrogen (e.g. by a carbon layer). The differential shift of the Bragg wavelength will then only be due to hydrogen and the monitoring accuracy can be improved considerably.

An optical fibre can be placed directly in the area to be monitored, but because of the material (glass) and typical dimensions of optical fibres (diameter in the order of 0.1 mm), it represents a fairly vulnerable sensing element. To increase the strength, optical fibres are usually protected by some type of coating. For ordinary tele- and data communications, one or two layers of acrylate are frequently used (overall outer diameter 0.25 mm). For applications at higher temperature, polyimide is often applied. Metal-coated fibres can be used at even higher temperatures.

Even with polymer layers an optical fibre is not very rugged. However, optical fibres can be packaged inside small tubes of different materials (e.g. steel) for protection. The tubes can be installed in the areas to be monitored and thereby represent a sensing element for environmental monitoring. Loss monitoring in a fibre will be a continuous sensor, while Bragg gratings will represent sensors at specific points.

The tube material and dimensions (outer diameter and wall thickness) will influence the diffusivity of hydrogen gas into the fibre (or Bragg grating) and the overall sensitivity and time constant of the sensor system.

Based on the fibre optic sensing techniques and the possibility for hydrogen detection disclosed herein, various sensing configurations can be utilised. The most direct monitoring will be for processes that generate hydrogen themselves, like corrosion of metal. Corrosion is a reaction usually separating water into hydrogen and a metal oxide.

To make the sensing system more effective and/or more selective, an additional reactive element can be applied. As an example, ordinary iron can be used in the sensor to detect water even through the construction is made of stainless steel.

To detect other substances, components that react efficiently with these substances can be utilised. For example, carbon dioxide (CO₂) and hydrogen sulfide (H₂S) can be detected by measuring the hydrogen generated when these dissolve in water in the presence of suitable reactants. H₂S hydrolyses (dissolves) in water and, depending on the pH, ionises to establish an equilibrium with H⁺, HS⁻ and H₂S(aq). CO₂ dissolves in water and establishes an equilibrium with H₂CO₃(aq), which further, depending on the pH, ionises to form H⁺, HCO₃⁻ and CO₃²⁻. The solubility of zinc (Zn) and magnesium (Mg) is proportional to the H⁺-concentration in the solution, subject to the condition that there are no passivating surface films. These metals will react and form H₂ which can be detected. This will yield the pH of the solution and a good indication of the rate of corrosion in anaerobic conditions.

Separate measurement of CO₂ and H₂S may be more difficult. A possible solution would be to use chemicals which react selectively with H₂S forming H₂ and sulfates. H₂S is a weakly oxidating material, but would be able to reduce e.g. Fe₃⁺ to Fe²⁺ and MnO₂ to Mn²⁺. This reaction forms sulphur and H⁺, yielding an increase in pH in the surrounding environment which normally would be detectable using e.g. a reaction with zinc to indicate H₂S.

There are of course a variety of other material combinations that can be used to generate hydrogen to utilise the sensing principle.

Based on presently disclosed techniques for fibre packaging, various sensing elements can be made. The sensitivity of the fibre itself can be optimised by using a fibre with e.g. germanium dopants in the core. To detect hydrogen most efficiently, only polymer coatings (with high diffusivity to hydrogen) should be applied onto the fibre. To increase sensitivity, a reactive element can be added to or on the outside of the fibre coating. The generation of hydrogen will then take place close to the fibre and the sensing system can then utilise the gas efficiently.

Fibre protection by an outer tube makes it possible to add the reactive element in the tube wall or at the outside. Various elements can easily be added in or at the surface of polymer tubes. Protective tubes made of materials with high diffusivity will not influence much on the response time either.

For protective metal tubes the metal itself can be the reactive element, or a layer of reactant can be deposited on the outside. Metal tubes represent a rugged protection, but they are also a barrier to hydrogen diffusion that will affect sensitivity and response time. The tube material and wall thickness can be selected to optimise the sensing performance. A polymer or other suitable material on the outside of the metal tube can include the reactant to ensure that the hydrogen generation takes place close to the tube wall.

The reactant can also be applied as part of a separate element in the area to be monitored to start the generation of hydrogen gas. The reactant can also be applied on all or some of the parts that represent the surroundings to be monitored.

For some applications the reactant can be a liquid or a part of a mixture (fluid or grease) that is enclosed in the area to be monitored.

The sensing principle is based on the detection of (hydrogen) gas. When the hydrogen is a result of oxidation of the reactant in the sensor system, this is a nonreciprocal process. The reactant will be consumed and cannot be replaced without replacing the reactant element itself. If, however, a catalyst is used, the catalyst will normally not be consumed in the reaction process.

In fibres with dopants in the core, some of the additional loss is permanent and the loss will not return to its initial value even though the hydrogen is removed from the fibre core (out diffusion).

These limitations might not represent severe problems in applications where the major objective is to detect whether a material has appeared (alarm function) or that a critical process has started (e.g. corrosion).

Although the invention has been described in terms of preferred embodiments as set forth above, it should be understood that these embodiments are illustrative only and that the claims are not limited to those embodiments. Those skilled in the art will be able to make modifications and alternatives in view of the disclosure which are contemplated as falling within the scope of the appended claims.

References

[1] “Reliability of optical fibers exposed to hydrogen: prediction of long-term loss increases”, P. J. Lemaire, i Optical Engineering, June 1991, Vol. 30, no. 6.

1. A system for use in the detection or measurement of at least one characteristic relating to a chemical environment, the system comprising:
an optical fibre arranged to receive light from an optical source;
the system being adapted to let a gas derived from said chemical environment diffuse into the optical fibre thereby altering the optical properties of the optical fibre, so that changes in the optical properties of the optical fibre due to the in-diffusion of said gas can be determined by optical signal detection and signal analysing means for deriving from the determined changes at least one characteristic value representing the chemical environment.

2. A system according to claim 1, comprising reaction elements or catalysts adapted to react or interact with constituents of the chemical environment so as to create said gas.

3. A system according to claim 2, wherein the reactive element(s) or catalyst(s) is/are added to or on the outside of the fibre coating of the optical fibre.

4. A system according to claim 2, wherein the reactive element(s) or catalyst(s) is/are added to or on the outside of a tube element provided for protection and packaging of the optical fibre.

5. A system according to claim 2, wherein the one or more reactive elements or catalysts comprises metals.

6. A system according to claim 2, wherein the one or more reactive elements or catalysts comprises elements capable of undergoing a chemical reaction, such as a corrosion process, thereby generating said gas.

7. A system according to claim 6, wherein the one or more reactive elements or catalysts comprises iron, the iron generating said gas, whereby a value representing the ingress of water and the start of a corrosion process can be derived from the determined changes.

8. A system according to claim 6, wherein the metal elements comprises zinc, the zinc generating said gas, whereby a pH-value representing the chemical environment can be derived from the determined changes.

9. A system according to claim 5, wherein the metal elements comprises magnesium, in order to enable the detection or measurement of carbon dioxide by detection or measurement of the hydrogen formed during a reaction process including the carbon dioxide and metal elements.

10. A system according to claim 6, wherein the metal elements comprises zinc, in order to enable the detection or measurement of hydrogen sulfide by detection of the hydrogen gas formed in a reaction process including the hydrogen sulfide and the metal elements.

11. A system according to claim 1, wherein the in-diffusion of said gas causes an additional loss in the light transmitted in the optical fibre.

12. A system according to claim 1, wherein the change in the optical properties of the optical fibre is enhanced by suitable dopants in the fibre, e.g. germanium or phosphorous.

13. A system according to claim 1, wherein the fibre is coated with a coating comprising a material with high diffusivity to the gas.

14. A system according to claim 13, wherein the coating comprises polymers with high diffusivity to gas.

15. A system according to claim 1, further comprising inlet means arranged to allow a sample or part of the chemical environment to enter the system.

16. A system according to claim 2, wherein the one or more reaction elements contribute to the galvanic protection of metal armouring.

17. A system according to claim 1, wherein the gas is hydrogen.

18. A system according to claim 1, further comprising a light source for launching light into the optical fibre.

19. A sensor system comprising a system according to claim 1, and optical signal detection and signal analysing means adapted to determine said changes in the optical properties of the optical fibre and to derive from the determined changes said at least one characteristic value.

20. A sensor system according to claim 11, further comprising optical transmission measurement means for obtaining a measure of the additional loss by measuring the transmission loss of the optical fibre.

21. A sensor system according to claim 11, comprising optical measurement means for determining the magnitude and location of the additional losses along the fibre.

22. A sensor system according to claim 21, wherein the optical measurement means comprises an OTDR (Optical Time Domain Reflection) apparatus.

23. A sensor system according to claim 20, further comprising optical measurement means for measurement of at least two optical wavelengths, the first optical wavelength being within an absorption peak caused by the gas, the second optical wavelength being outside the absorption peak caused by the gas, the sensor system further comprising comparison means for comparing the measurements at said at least two wavelengths in order to compensate for losses caused by mechanisms other than in-diffusion of the gas.

24. A sensor system according to claim 23, wherein the comparison means is arranged to compensate for losses caused by bending of the fibre.

25. A sensor system according to claim 23, wherein the first peak is at 1244 nm and the second peak at about 1300 nm.

26. A sensor system according to claim 19, wherein the optical fibre comprises one or more FBG (Fibre Bragg grating)-elements, the Bragg wavelength of the Bragg grating(s) depending on the in-diffusion of said gas, and wherein the optical detection and signal analysing means comprises means for measuring the shift of the reflected Bragg wavelength of at least one of the FBG elements due to the in-diffusion of said gas.

27. A sensor system according to claim 26, comprising means for compensating for wavelength changes caused by mechanisms other than in-diffusion of the gas.

28. A sensor system according to claim 27, wherein the compensating means is arranged to compensate for temperature changes.

29. A sensor system according to claim 27, wherein at least two FBGs are provided, and the compensating means is arranged to measure the reflected Bragg wavelengths of the at least two FBGs, wherein at least one FBG is exposed to the gas and at least one other FBG is protected from the gas.

30. A sensor system according to claim 29, wherein a carbon layer is provided for protection of said other FBG.

31. A sensor system according to claim 29, wherein the at least two FBGs are closely spaced.

32. A detection or measurement assembly for use with a system of claim 1, the assembly comprising:
optical signal detection and signal analysing means arranged to determine changes in the optical properties of the optical fibre due to the in-diffusion of the said gas, and to derive from the determined changes at least one characteristic value representing the chemical environment.

33. Use of a system, a sensor system or an assembly according to claim 1 as a sensor for monitoring the corrosion and/or the environmental conditions of flexible risers in offshore environments.

34. A method of detecting or measuring at least one characteristic relating to a chemical environment, comprising:
launching light into an optical fibre;
letting a gas derived from the chemical environment diffuse into the optical fibre, thereby altering the optical properties of the optical fibre;
detecting and analysing light from the optical fibre so as to determine changes in the optical properties of the optical fibre due to the in-diffusion of said gas; and
deriving said at least one characteristic value representing the chemical environment from the determined changes.
